(19) United States
(12) Patent Application Publication
(10) Pub. No.: US 2006/0068808 A1
(43) Pub. Date: Mar. 30, 2006

(54) Method, System and apparatus for using mobile telephone and GPS receiver to inexpensively access the server based GIS context for navigation operations

(75) Inventor: Dimitrios Karavias, Portland, OR (US)

Correspondence Address: Dimitrios Karavias, 3518 NE Couch Street, Portland, OR, 97232, US

(73) Assignee: Dimitrios Karavias, Portland, OR (US)

(21) Appl. No.: 10/711,577

(22) Filed: Sep. 25, 2004

(51) Int. Cl. H04B 7/185

(52) U.S. Cl. 455/456.1; 455/411

(57) ABSTRACT

Method, system and apparatus for using a mobile phone with GPS receiver attached are provided for navigation operation. The GPS device locates coordinates using the Satellite Positioning System (SPS). An apparatus and method are invented to convert the GPS coordinates into encoded voice prompts, text messages or touch-tone signals. The mobile telephone is used to transmit the encoded coordinates to a GIS server. Based on a pre-configured context, the GIS server is engaged to provide point of interest (POI) GIS information. The predetermined context includes preferences such as destination by name or proximity, language, category class of the destination. Based on the received GPS coordinates and preference context, GIS context is generated and received by the mobile telephone as either voice or text prompts. Thus, the method provides cost effective access to the GIS context using existing mobile telephone infrastructure.

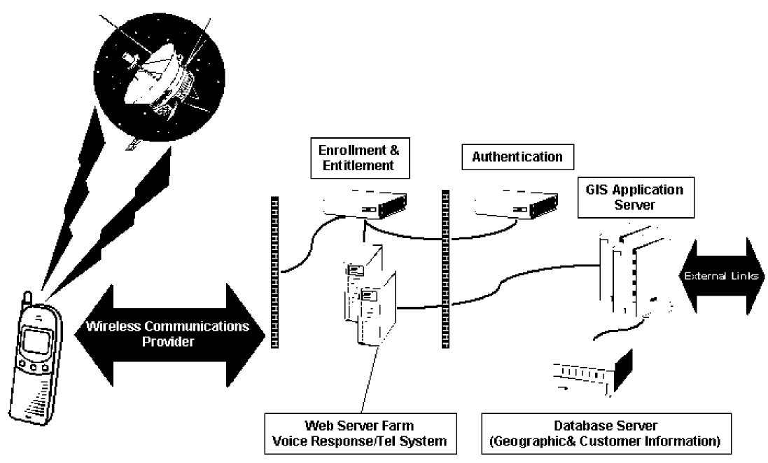

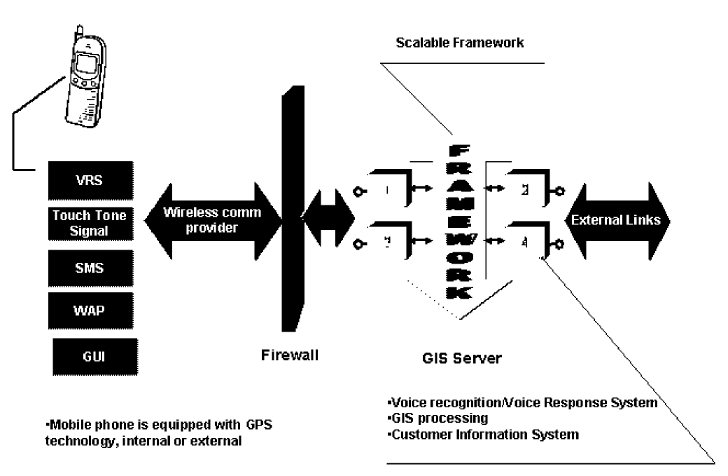

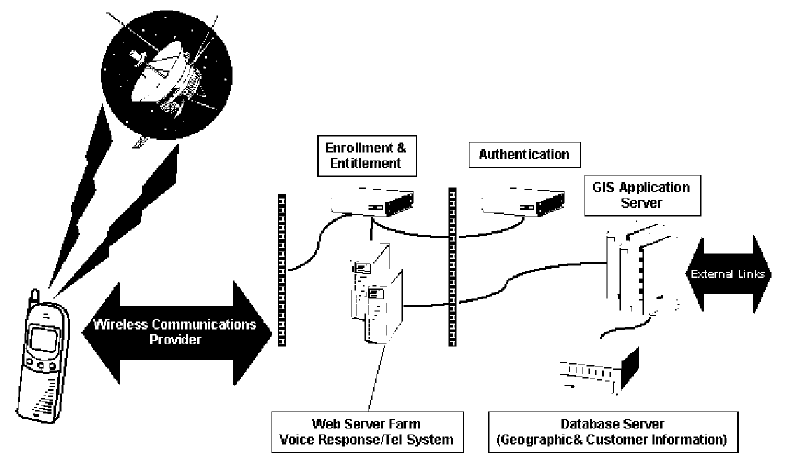

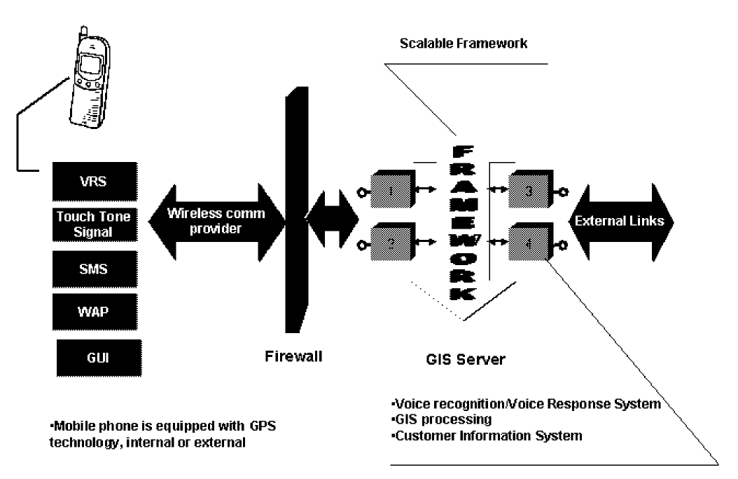

### FIELD OF INVENTION

The present invention relates to integrating a mobile telephone and a GPS receiver and a method capable in converting coordinates to touch-tone signals, text or voice messages, which are communicated to a GIS server to make GIS and navigation information available to mobile telephone users in a convenient and inexpensive way.

### DESCRIPTION OF THE RELATED ART

Computerized mapping and real-time communication software are independently achieving widespread use today. Such mapping programs are commonly used to automate tasks of calculating routes, viewing location-specific geographical areas for their spatial content, such as addresses, roadways, rivers, etc., and for the purpose of being used with Global Positioning System (GPS) devices for various applications, such as a personal navigation application. Mapping software programs apply to a wide variety of uses, such as personal navigation, telemetric, thematic mapping, resource planning, routing, fleet tracking, safety dispatching (i.e., Police, Fire, and Rescue organizations), and a wide variety of specialized Geographic Information System (GIS) applications, all of which are well known to people skilled in the art.

Prior art applications provide various features, such as displaying driving directions (i.e., routes), Points Of Interest (POI), waypoints (such as personalized, user-specific, points on a route or along a track), etc. To aid such navigation, special device is usually engaged such as a GIS capable palm computer or a dedicated GIS displayer. A typical user feeds-in the POI, the device calculates the distance from the current GPS coordinates and gives real-time directions to the destination. This system requires a GPS ready device with built in GIS database such that the GPS coordinates can be mapped to the GIS. Since the GIS information is saved on a local device and the software to map GPS coordinates to GIS reside on one local unit, the unit becomes expensive. Additionally it requires to carry this extra unit to be able to access the GIS.

Current applications that integrate both mapping and real-time messaging are well known in the art, such as the Automatic Vehicle Location (AVL) or Fleet Tracking industry, where vehicles that have position devices, such as GPS, report their position to a centralized computer for the mapping and display of the vehicles' locations. Some of these prior art systems may incorporate real-time messaging for the transfer of logistical information, such as pickup and drop-off status messages. However, these existing applications do not provide a method for dynamically transferring location-relevant information to a device such as a mobile telephone without the local GIS, Graphical User Interface (GUI) and software to map GPS to GIS.

Mobile devices typically use location telemetry devices to transmit their location in a pre-defined manner or by request, by using a set of preferences to automatically request position updates. These preferences are based on various parameters, such as reporting location updates based on the distance traveled by the vehicle or by using various time intervals to trigger position updates either by a push or pull method relative to the telemetry device.

One of the problems with the AVL solution is that most applications are browser based, requiring maps, which are either GUI or Character Based. Such applications are widespread with mobile devices such as the ones manufactured by Garmin, and MapQuest Corporation. There are also software applications such as Microsoft MapPoint to lead a user to a POI. This prior art fails to use the existing mobile telephone devices not equipped with GUI, GPS and mapping software explained above.

Another problem with the prior art, such as the case of AVL software solution is that the mobile device is limited in its functionality by such practical aspects as the limited size of portable hard disk, memory and software functionality. For example, the device may only be able to hold the detailed maps of some routes of North America but not necessarily fleet vehicle sea maps. The POI enabled mobile device and software tends to be relatively larger and extra piece to carry as most of the people using this device also uses a mobile telephone—relatively smaller and inexpensive equipment.

Also, the device that is equipped to direct in English will be of little use for a traveler operating the device in Japan without changing the language option. The GIS server based solution offers a centralized database with a potentially very large data storage, many more GIS applications and features. Once engaged in session, a user can opt for such preferences such as a language of choice or level of details in GIS. The prior art also falls short for travelers outside the geographical bounds of the installed maps, or those who require different application based on the geographical context of the POI.

The current art cannot effectively track the use of GIS features. The proposed model not only gives expanded GIS features, but also provides a way of offering pay per use of the service.

The current art does not allow a standard mobile telephone to offer POI information or navigation capabilities to a user.

Thus, a need exits for a method and system that allows users with a mobile telephone to send, request, and plan, in real time, location relevant information. Until now, an adequate solution to these problems is confined to a smaller user population having a GUI capable POI device. This solution is limited in its functionality. Providing a solution enabling users to send, request, and plan, in real time, location relevant information would prove especially useful for wireless mobile phones that incorporate a GPS device.

This provides great benefits to wireless telephone users as they can use the mobile telephone to harness the information currently only available to the in-vehicle navigational systems (i.e., telematics) and fleet tracking systems. They would be able to make use of the existing infrastructure of the mobile telephone and much larger application support from the GIS server.

What is claimed is:

1. A GIS server is engaged using a mobile phone. A POI is communicated to the GIS server through a mobile telephone. POI context can be communicated by methods such as voice recognition/response system (VRS), a push button technology or a Graphical User Interface (GUI). The GIS server is then engaged in session with the mobile telephone.

2. A method and apparatus is invented to convert the GPS coordinates to a voice or text messages or touch-tone signals.

3. A method and apparatus is invented to communicate the GPS coordinates of the mobile telephone to the GIS server. The GPS coordinates are converted into encoded voice, text messages or touch-tone signals. The messages or signals are used to communicate the coordinates of the mobile telephone to the GIS server.

4. The mobile device session with the GIS server is established in three phases; Session Establishment, Session Engagement and Session Release.

5. A session is established once the GIS server authenticates the validity of session request from the mobile telephone.

6. While the session is engaged, GIS server guides for the destination point of interest, by the way of verbal or graphical commands. Thus the GIS information is server based as opposed to the current convention of storing it on the local (client) based unit. During the entire course of engagement, the server gets the GPS coordinates of the mobile device at predetermined regular intervals and it continues to guide to the destination of interest. GIS verifies the authenticity of the established session during each request and response.

7. The mobile telephone of claim 1, based on its capacity can optionally receive textual information from the GIS server. The textual information exchange in the form of request and response during the established session can optionally be standardized using standard protocols such as WAP and WML.

8. The GIS response can optionally be a complete route message or in the form of turn by turn instructions.

9. The mobile telephone of claim 1, based on its capacity can optionally receive graphical information from the GIS server to display on the mobile phone unit.

10. The engagement session of claim 1 is optionally initiated by voice prompts, using a voice recognition server/unit.

11. The engagement session of claim 1 is optionally initiated by graphical prompts on the mobile telephone.

12. The navigational request (command) of claim 2 is created by encoding the GPS coordinates as voice commands.

13. The command of claim 2 is optionally created by encoding the GPS coordinates as textual input.

14. The command of claim 2 is optionally created by pushing the buttons on the mobile telephone or transmitting the encoded touch-tone signals.

15. The GIS guidance is server based enabling it to become a service. The service in claim 15 can optionally be engaged to metering and billing system to offer a variety of navigational choices. Not a claim.
